(19) United States
(12) Patent Application Publication
(10) Pub. No.: US 2006/0150654 A1
(43) Pub. Date: Jul. 13, 2006

(54) Cup holder

(76) Inventor: Klaus Arold, Sindelfingen (DE)

Correspondence Address: KENYON & KENYON LLP, ONE BROADWAY, NEW YORK, NY, 10004, US

(21) Appl. No.: 10/536,562

(22) PCT Filed: Oct. 21, 2003
(86) PCT No.: PCT/EP03/11617

§ 371 Date: Oct. 4, 2005

(30) Foreign Application Priority Data
Nov. 28, 2002 (DE) 10255444.7

(51) Int. Cl. F25B 21/02; B60H 1/32

(52) U.S. Cl. 62/244; 224/926; 62/3.61

(57) ABSTRACT

A cup holder for a motor vehicle includes a receiving device and a tempering device which is connected to an air-conditioning system. The air-conditioning system generates an air flow which is conveyed via an air-directing device to a beverage container which is retained in the receiving device. In order to provide a cup holder which is easily accessible to an occupant and may be tempered at the same time, the receiving device may be pulled out of a housing while remaining connected to the air-conditioning system.

### FIELD OF THE INVENTION

The present invention relates to a cup holder for a motor vehicle.

### BACKGROUND INFORMATION

German Published Utility Model No. 89 11 649 describes a cup holder for a motor vehicle that is fitted into an existing duct of an air-conditioning system of the motor vehicle. A fan of the air-conditioning system generates an air flow which is conveyed via air-directing devices to a beverage container which is retained in a receiving device arranged in the duct of the air-conditioning system. The receiving device is an opening which is introduced in the duct of the air-conditioning system and can be closed by a lid.

When the lid is open, a beverage container can be inserted into the receiving device, so that the air conveyed by the fan flows around the beverage container. Since the beverage container has to be arranged directly in the air flow, i.e., in the duct of the air-conditioning system, the cup holder may, under some circumstances, be arranged in the vehicle at a location to which access is difficult for the occupant.

### SUMMARY

According to an example embodiment of the present invention, a cup holder is provided which may be arranged in a vehicle independently of the position of the air-conditioning system.

The cup holder may have a receiving device which may be pulled out from a housing. The housing is connected to the air-conditioning system, so that the air flow of the air-conditioning system may be directed directly into the receiving device. If a beverage container is now to be introduced into the cup holder, then the receiving device is pulled out from the housing while remaining connected to the air-conditioning system, and the beverage container is inserted. If the cup holder is no longer required, the receiving device may be pushed again into the housing. Since the beverage container does not have to be arranged directly in the air flow of the air-conditioning system, the cup holder may be arranged virtually anywhere in a motor vehicle.

An air-directing device may be integrated in the receiving device and may direct the air flow conveyed by the air-conditioning system as far as a retaining opening introduced into the receiving device.

In an example embodiment, the air-introducing device may have two inflow ducts which lead into an annular duct around the retaining opening. The retaining opening of the receiving device is formed by a cylindrical wall into which discharge openings are introduced. The air of the air-conditioning system may therefore flow via the two inflow ducts into the annular duct and may emerge through the outflow openings and may flow around the beverage container retained in the retaining opening.

An inlet opening which, for example, is provided with a connecting branch may be introduced into the housing. A connecting duct which connects the air-conditioning system and the inlet opening to each other is connected to the connecting branch. In the not-in-use position of the cup holder, a rear wall of the receiving device may close the inlet opening.

In order to avoid flow loss, a seal may be arranged between the rear wall and a wall region of the housing, which wall region surrounds the inlet opening, which seal, in the not-in-use position, is pressed by the rear wall of the receiving device against the wall region.

In order to temper optionally warm or hot beverage containers, the connecting duct may be connected by a first connection to an evaporator and by a second connection to a heat exchanger of the air-conditioning system. A switch arranged in the connecting duct may be activated, for example, by a stepping motor, so that the user may connect either the first or the second connection.

Example embodiments of the present invention are explained below with reference to the appended Figures.

### BRIEF DESCRIPTION OF THE DRAWINGS

FIG. 1 is a cross-sectional view of a cup holder.

FIG. 2 is a cross-sectional view taken long the line II-II illustrated in FIG. 1.

FIG. 3 is a cross-sectional view taken along line III-III illustrated in FIG. 1.

FIG. 4 is a schematic view of an air-conditioning system of a motor vehicle.

### DETAILED DESCRIPTION

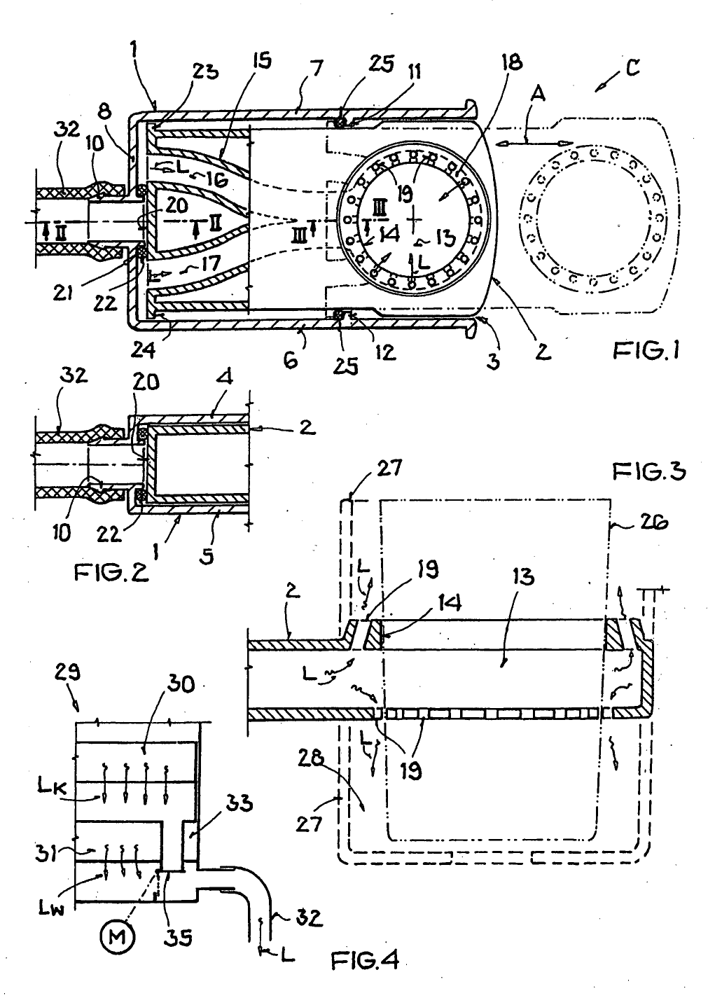

The cross-sectional view of FIG. 1 illustrates a cup holder C having a housing 1 in which a receiving device 2 is mounted displaceably in accordance with arrow A. The housing 1 is of box-shaped design and has an opening 3 on the front side, two side walls 6 and 7 arranged parallel to each other and a rear end wall 8. The side walls 6 and 7 and the rear end wall 8 are connected to one another by an upper covering 4 and a base 5 (cf. FIG. 2). An inlet opening 9 from which a connecting branch 10 protrudes is introduced into the rear end wall 8. Two stops 11 and 12 protrude from the insides of the side walls 6 and 7 into the interior of the housing 1.

A retaining opening 13 is introduced into the receiving device 2. The retaining opening 13 is formed by a cylindrical wall 14 of the receiving device 2 and serves for the insertion of a beverage container.

An air-directing device 15 which has two inflow ducts 16 and 17 is integrated in the receiving device 2. The inflow ducts 16 and 17 lead into an annular duct 18 which surrounds the cylindrical wall 14 of the retaining opening 13. Discharge openings 19 are arranged in the cylindrical wall 14. The air L flowing in through the inflow ducts 16 and 17 is therefore directed by the air-directing device 15 to the annular duct 18 and flows there through the discharge openings 19 into the retaining opening 13.

The receiving device 2 has a rear wall 20 which closes the inlet opening 9 of the housing 1 when the receiving device 2 is retracted.

A seal 22 arranged between the rear wall 20 and a wall region 21 of the housing 1, which wall region surrounds the inlet opening 9, may ensure that the air generated by the air-conditioning system may not flow into the receiving device 2 as long as the cup holder C is in the not-in-use position.

The receiving device 2 has fittings 23 and 24 on both sides which, together with the stops 11 and 12 of the housing 1, form an extension limit. So that, in the extended state of the receiving device 2, no flow losses may occur between the housing 1 and receiving device 2, a seal 25 is arranged between the stops 11 and 12 and the fittings 23 and 24. The extended state of the receiving device 2 is indicated by chain-dotted line.

As illustrated in the cross-sectional view of FIG. 3, the air L of the air-conditioning system flows out of the discharge openings 19 and along the beverage container 26 introduced into the retaining opening. For this purpose, the discharge openings 19 are introduced both on the upper side and on the lower side of the cylindrical wall 14. In order to achieve an optimum flow, an insert 27 may be provided, so that between the beverage container 26 and the insert 27 an air gap 28 is formed into which the air L may flow in accordance with the illustrated arrows.

FIG. 4 schematically illustrates an air-conditioning system 29. The air-conditioning system 29 includes an evaporator 30 and a heat exchanger 31. The evaporator 30 generates cold air L_{K} while the heat exchanger 31 heats warm air L_{W}. A connecting duct 32 is connected to the air-conditioning system 29 by a first connection 33 and a second connection 34. The first connection 33 is connected to the evaporator 30 and the second connection 34 is connected to the heat exchanger 31. A switch 35 is arranged in the connecting duct 32 and is activated by a stepping motor M, so that either the first connection 33, i.e., cold air L_{K}, or the second connection 34, i.e., warm air L_{W}, is connected.

The air flow L generated is directed to the connecting branch 10 via the connecting duct 32.

The switch 35 is activated by the occupant, for example, by actuating a switch in the motor vehicle interior, so that he may select warm air L_{W} or cold air L_{K} as a function of the inserted beverage container 26.

1-10. (canceled)

11. A cup holder for a motor vehicle, comprising:
a housing;
a receiver device arranged to retain a beverage container, the receiver device including a retaining opening; and
a tempering device including an air-directing device arranged to convey an air flow from an air-conditioning system to the beverage container;
the receiver device configured to be pulled out of the housing while remaining connected to the air conditioning system, the air-directing device integrated in the receiver device and arranged to direct the air flow to the retaining opening, the air-directing device including two inflow ducts connected to an annular duct arranged around the retaining opening.

12. The cup holder according to claim 11, wherein a wall that forms the retaining opening includes discharge openings.

13. The cup holder according to claim 11, wherein the housing includes an inlet opening.

14. The cup holder according to claim 13, wherein a rear wall of the receiver device is arranged to close the inlet opening when the receiver device is in a retracted position.

15. The cup holder according to claim 14, further comprising a seal arranged between the rear wall and a wall region of the housing that surrounds the inlet opening.

16. The cup holder according to claim 11, further comprising a connection duct connecting the air-conditioning system to an inlet opening.

17. The cup holder according to claim 16, wherein the connection duct is connected by a first connection to an evaporator of the air-conditioning system and by a second connection to a heat exchanger of the air-conditioning system.

18. The cup holder according to claim 17, further comprising a switch arranged in the connection duct and arranged to switch a connection of the connection duct between first connection and the second connection.

19. A cup holder for a motor vehicle, comprising:
housing means;
receiving means for retaining a beverage container, the receiving means including a retaining opening; and
tempering means including air-directing means for conveying an air flow from air-conditioning means to the beverage container;
the receiving means for being pulled out of the housing while remaining connected to the air conditioning means, the air-directing means integrated in the receiving means and for directing the air flow to the retaining opening, the air-directing means including two inflow duct means connected to annular duct means arranged around the retaining opening.

20. A cup holder for a motor vehicle, the motor vehicle including an air-conditioning system, comprising:
a housing;
a receiver device arranged to retain a beverage container, the receiver device including a retaining opening, an annular duct arranged around the retaining opening, the receiver device pullable out of the housing while remaining connected to the air conditioning system, the receiver device including an integral air-directing device arranged to direct an air flow to the retaining opening, the air-directing device including two inflow ducts connected to the annular duct.

21. A motor vehicle, comprising:
an air-conditioning system; and
a cup holder including:
a housing;
a receiver device arranged to retain a beverage container, the receiver device including a retaining opening; and
a tempering device including an air-directing device arranged to convey an air flow from the air-conditioning system to the beverage container;
the receiver device configured to be pulled out of the housing while remaining connected to the air conditioning system, the air-directing device integrated in the receiver device and arranged to direct the air flow to the retaining opening, the air-directing device including two inflow ducts connected to an annular duct arranged around the retaining opening.
